(19) United States
(12) Patent Application Publication
(10) Pub. No.: US 2004/0107750 A1
(43) Pub. Date: Jun. 10, 2004

(54) Electrically-operated steering lock device

(76) Inventor: Keisuke Fukushima, Aki-gun (JP)

Correspondence Address: WENDEROTH, LIND & PONACK, L.L.P., 2033 K STREET N. W., SUITE 800, WASHINGTON, DC, 20006-1021, US

(21) Appl. No.: 10/716,450

(22) Filed: Nov. 20, 2003

(30) Foreign Application Priority Data
Dec. 5, 2002 (JP) 2002-354285

(51) Int. Cl. B60R 25/02

(52) U.S. Cl. 70/186

(57) ABSTRACT

An electrically-operated steering lock device, having a lock bolt which is movable between a protrusion position where the steering shaft is locked and a retreat position where the steering shaft is unlocked, and a cam member which is rotated by an electric motor to actuate the lock bolt, is further provided with rotation blocking means which is electrically driven and which, when the lock bolt is placed at the retreat position, engages with a first engagement portion formed in the cam member to block rotation of the cam member, and holding means for holding the rotation blocking means in a state that rotation of the cam member is blocked. In the electrically-operated steering lock device, the steering shaft is not locked during a running of vehicle even if any electrically-operated member has malfunctioned due to noise or the like.

### BACKGROUND OF THE INVENTION

The present invention relates to an electrically-operated steering lock device which is prevented from locking the steering shaft even if an electrically-operated member has malfunctioned due to noise or the like.

Conventionally, an electrically-operated steering lock device, as disclosed in, for example, Japanese Patent Laid-Open Publication No. 2002-234419, is so designed that a lock bolt (lock pin) is driven by a plate cam coupled to an electric motor so that the lock bolt is protruded toward a steering shaft so as to be engaged with the steering shaft, and thus locked. Further, with an engagement concave portion formed in the plate cam, a plunger of a solenoid is engaged with the engagement concave portion so that even if the electric motor malfunctions, the lock bolt is prevented from popping out by keeping the plate cam from rotating with a hold by the plunger.

However, in this electrically-operated steering lock device, there has been a problem that when the solenoid and the electric motor are simultaneously driven due to noise or the like during a running of vehicle, the solenoid may pull in the plunger so that its engagement with the plate cam is released, where at this timing of releasing, the electric motor rotates to make the lock bolt protruded toward the steering shaft, thus locking the steering shaft.

### SUMMARY OF THE INVENTION

The present invention having been accomplished in view of these and other problems of the prior art, an object of the invention is to provide an electrically-operated steering lock device which keeps the lock bolt from protruding even if electric currents flow through the electric motor and the solenoid at the same time by an arrangement that a protrusion blocking means, such as a solenoid or the like, for blocking the protrusion of the lock bolt is prevented from malfunctioning even if an electric current is passed through the protrusion blocking means during a running.

In order to achieve the above-described object, the present invention provides an electrically-operated steering lock device comprising a lock bolt which is movable between a protrusion position where a steering shaft is locked and a retreat position where the steering shaft is unlocked, and a cam member which is rotated by an electric motor to actuate the lock bolt, the electrically-operated steering lock device further comprising: rotation blocking means which is electrically driven and which, when the lock bolt is placed at the retreat position, engages with a first engagement portion formed in the cam member to block rotation of the cam member; and holding means for holding the rotation blocking means in a state that rotation of the cam member is blocked.

With this constitution, even if electric currents have flowed simultaneously through both the electric motor and the rotation blocking means due to noise or the like so that the cam member and the rotation blocking means are driven, the rotation blocking means is held by the holding means, so never activated. Thus, the possibility that the lock bolt may erroneously be protruded to make the steering shaft locked can be eliminated reliably.

Further, in the electrically-operated steering lock device according to the invention, the cam member may act to move the lock bolt to the protrusion position when the electric motor is rotated forward, and to move the lock bolt to the retreat position when the electric motor is rotated reverse.

With this constitution, the lock bolt is not actuated to the protrusion position by biasing force of a spring or the like, but is moved to the protrusion position by the cam member. Therefore, even in the event that strong vibrations are caused to act during the running of the vehicle with the rotation blocking means and the cam member disengaged from each other, the lock bolt is never mis-protruded, so that the safety can be further improved.

Further, in the electrically-operated steering lock device according to the invention, the holding means may be a second engagement portion formed in the cam member, where in a state that engagement with the second engagement portion has been released by reverse rotation of the electric motor, the lock bolt is protrudable by forward rotation of the electric motor.

With this constitution, in order to make the lock bolt protruded, the electric motor needs to be once rotated reverse before the electric motor is rotated forward, and then, in this state, the engagement between the rotation blocking means and the holding means needs to be released. There is no possibility that noise may enter at such a timing, so that mis-operations of the lock bolt can be blocked with more reliability.

Furthermore, in the electrically-operated steering lock device according to the invention, a cam portion of the cam member may be formed in such a manner that the lock bolt is not actuated at a time of release operation that the engagement with the second engagement portion is released by reverse rotation of the electric motor.

With this constitution, since there is no need for rotating the lock bolt from the retreat position further in the retreat direction, the working range of the lock bolt can be narrowed, thus making it possible to downsize the electrically-operated steering lock device.

Also, the electrically-operated steering lock device according to the invention may further comprise lock bolt holding means for holding the lock bolt at the retreat position while the lock bolt is placed at the retreat position.

With this constitution, even if the cam member is not engaged with the lock bolt, the lock bolt can be prevented from rattling, so that unusual noise due to vibrations of the lock bolt never occurs.

### BRIEF DESCRIPTION OF THE DRAWINGS

The present invention will be further described with reference to the accompanying drawings wherein like reference numerals refer to like parts in the several views, and wherein:

FIG. 1 is a cross-sectional bottom view showing an electrically-operated steering lock device according to an embodiment of the invention;

FIG. 2 is a cross-sectional front view taken along the line A-A of FIG. 1;

FIG. 3 is a cross-sectional front view taken along the line B-B of FIG. 1;

FIG. 4 is a cross-sectional front view showing an unlocked state of FIG. 2;

FIG. 5 is a front view of the rotor of FIG. 2;

FIG. 6A is a front view showing the cam member of FIG. 2, and FIG. 6B is a side view of FIG. 6A;

FIG. 7 is a front view showing a coupled state of the rotor and the cam member of FIG. 2;

FIG. 8A is a plan view showing the slider of FIG. 3, FIG. 8B is a front view of FIG. 8A, and FIG. 8C is a side view of FIG. 8A;

FIG. 9A is a front view of a main part showing a state that the cam member of FIG. 3 has been rotated to the unlocked side to the most, and FIG. 9B is a front view of a main part showing a state of the switch cam shown in FIG. 1 under the state of FIG. 9A; and

FIG. 10A is a front view of a main part showing a state that the slider and the cam member of FIG. 3 have been engaged with each other, and FIG. 10B is a front view of a main part showing a state of the switch cam shown in FIG. 1 under the state of FIG. 10A.

### DETAILED DESCRIPTION OF THE PREFERRED EMBODIMENTS

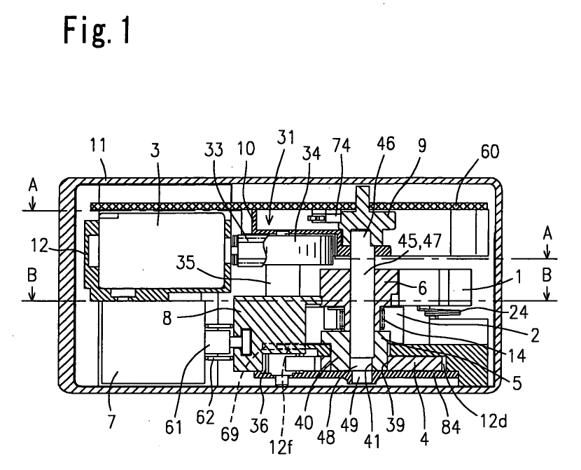

FIGS. 1, 2 and 3 show an electrically-operated steering lock device of an embodiment according to the present invention. This electrically-operated steering lock device is so constructed that two lock bolts 1, 2, an electric motor 3, a final reduction gear 4, a rotor 5, a cam member 6, a solenoid 7, a slider 8, a switch cam 9, and a base 10 for placing thereon these members are all arranged within a housing 11 and housed with a cover 12.

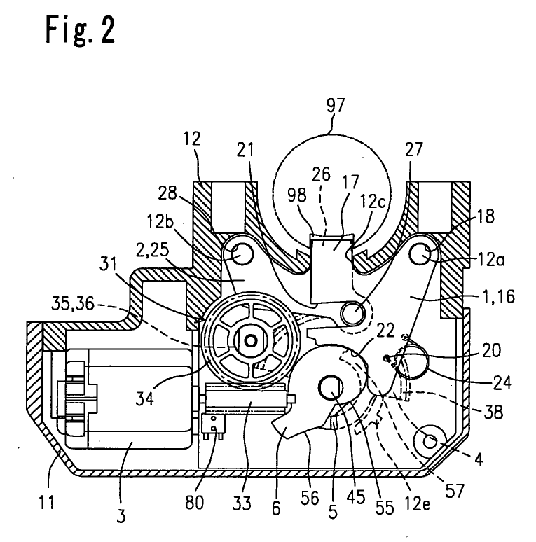

As shown in FIG. 2, the first lock bolt 1 comprises a platy body portion 16, and on one side of a steering shaft 97 side of the body portion 16 is provided a protruding piece 17 that is upwardly protruding. Also, on the other side of the steering shaft 97 side of the body portion 16 is provided a bearing hole 18. This first lock bolt 1 is pivotally held at its bearing hole 18 on a shaft portion 12a which is provided so as to protrude from the cover 12. As a result, the first lock bolt 1 is disposed right-hand downward of the steering shaft 97 in FIG. 2 so as to be rotatable about the shaft portion 12a. Then, when the first lock bolt 1 is rotated in a protruding direction (clockwise), the protruding piece 17 thereof is protruded outward from an opening portion 12c of the cover 12. The protruded protruding piece 17 is engaged with a receiving portion 98 of the steering shaft 97 of the vehicle, thereby locking the steering shaft 97.

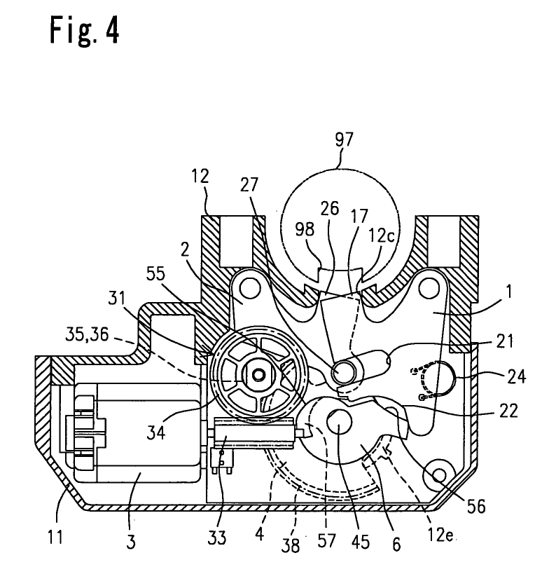

In the first lock bolt 1, a spring holding hole 20 for holding one end of an action spring 24, which is a lock bolt holding means, is formed on a lower side of the body portion 16. This action spring 24, which is variable in its biasing direction depending on the position of the first lock bolt 1, has the other end held by the cover 12. The action spring 24 biases the first lock bolt 1 toward the protruding direction (clockwise) when the first lock bolt 1 is placed at a protrusion position (a position shown in FIG. 2), and biases the first lock bolt 1 toward a retreat direction (counterclockwise) when the first lock bolt 1 is placed at a retreat position (a position shown in FIG. 4). Further, in the first lock bolt 1, a coupling-use concave portion 21 for actuating the later-described second lock bolt 2 is formed on a lower side of the protruding piece 17 of the body portion 16, while a generally arc-shaped contact surface 22 with which the later-described cam member 6 is to be brought into contact is formed on a lower side face of the body portion 16.

The second lock bolt 2 comprises a generally U-shaped, platy body portion 25, and on one side of a steering shaft 97 side of the body portion 25 is provided a protruding piece 26 that is upwardly protruding, while downward of this protruding piece 26 is provided a coupling convex portion 27 which is elongated into the coupling-use concave portion 21 of the first lock bolt 1 so as to be engaged therewith. Also, on the other side of the steering shaft 97 side of the body portion 25 is bored a bearing hole 28. This second lock bolt 2 is pivotally held at its bearing hole 28 on a shaft portion 12b which is provided so as to protrude from the cover 12. Thus, the second lock bolt 2 is rotatably disposed at a position counter to the first lock bolt 1 with the steering shaft 97 interposed therebetween, so that the coupling convex portion 27 is engaged with the coupling-use concave portion 21 of the first lock bolt 1, thereby making the second lock bolt 2 interlocked with the first lock bolt 1. Then, when the first lock bolt 1 is rotated in the protruding direction, the second lock bolt 2 is rotated in linkage together in the protruding direction, so that the protruding piece 26 of the second lock bolt 2 is protruded outward from the opening portion 12c of the cover 12, simultaneously with the protruding piece 17 of the first lock bolt 1. The protruded protruding piece 26, together with the protruding piece 17 of the first lock bolt 1, is engaged with the receiving portion 98 of the steering shaft 97 of the vehicle, thereby locking the steering shaft 97.

The electric motor 3, which is powered by unshown lines laid in the housing 11, is driven into forward and reverse rotation by an internal control circuit 60. Also, the electric motor 3, as shown in FIGS. 1 and 2, acts to rotate the final reduction gear 4 via a rotating mechanism 31. This rotating mechanism 31 is made up of a worm 33 fitted to a driving shaft of the electric motor 3, a large-diameter worm gear 34 to be meshed with the worm 33, and a coaxial small-diameter gear 36 provided integrally with a rotating shaft 35 of the worm gear 34. The small-diameter gear 36 is to be meshed with a segment gear 38 formed on the outer periphery of the final reduction gear 4. As a result of this, when the electric motor 3 is rotated forward, the small-diameter gear 36 is rotated counterclockwise in FIG. 2. As the small-diameter gear 36 is rotated counterclockwise, the final reduction gear 4 is rotated clockwise. Conversely, as the electric motor 3 is rotated reverse, the small-diameter gear 36 is rotated clockwise in FIG. 2, so that the final reduction gear 4 is rotated counterclockwise.

The final reduction gear 4, which is formed into a generally fan shape with the segment gear 38 formed on its outer periphery, is housed within a housing concave portion 12d formed in the cover 12 by a plate 84 that is a lid member so that the final reduction gear 4 can be rotated in the housing concave portion 12d. A generally D-shaped coupling hole 39 is formed at a center of the final reduction gear 4, and a coupling portion 40 of the rotor 5, which is a coupling member, is fitted into this coupling hole 39 and thereby coupled to the final reduction gear 4. Then, this final reduction gear 4 and the rotor 5 are pivotally held by a shaft 45 extending through a shaft insertion hole 41 provided at a rotational center of the rotor 5 and partly formed into a generally D-shaped cross section. The shaft 45 has an tip end portion 46 having a generally D-shaped cross section, a rotational portion 47 having a circular-shaped cross section, a fitting portion 48 having a generally D-shaped cross section, and a rear end portion 49 having a circular-shaped cross section, as listed from the upside in FIG. 1. In this shaft 45, the rotational portion 47 and the rear end portion 49, which are circular-shaped in cross section, are pivotally held on the base 10 and the plate 84, respectively, so that the shaft 45 itself is held rotatable. Further, the fitting portion 48 of the shaft 45 is kept fitted in the shaft insertion hole 41 of the rotor 5, so that as the final reduction gear 4 is rotated, the rotor 5 and the shaft 45 are rotated together. It is noted that the final reduction gear 4 is regulated in its rotational range by a stopper 12e protrusively provided on the cover 11.

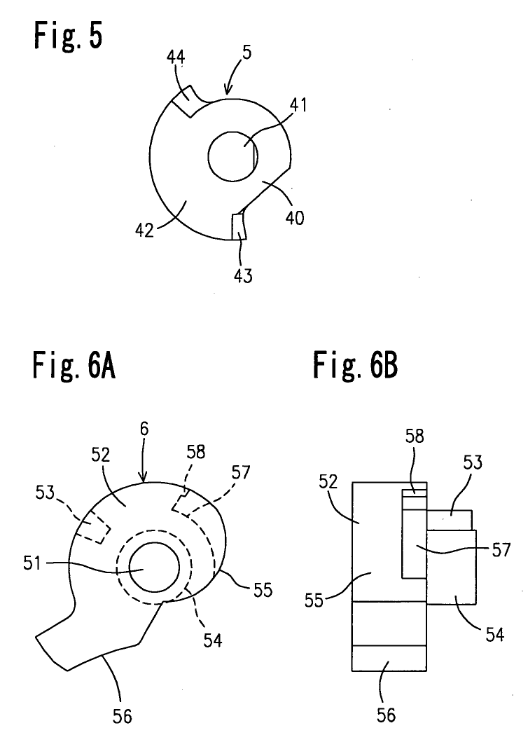

As shown in FIG. 5, on the upper surface of the coupling portion 40 of the rotor 5 is formed a flange portion 42 that is radially protruding in a generally fan shape, while on the upper surface of the flange portion 42, an upwardly-protruding spring-use engagement convex portion 43 and a rotation-use engagement convex portion 44 are provided at specified positions.

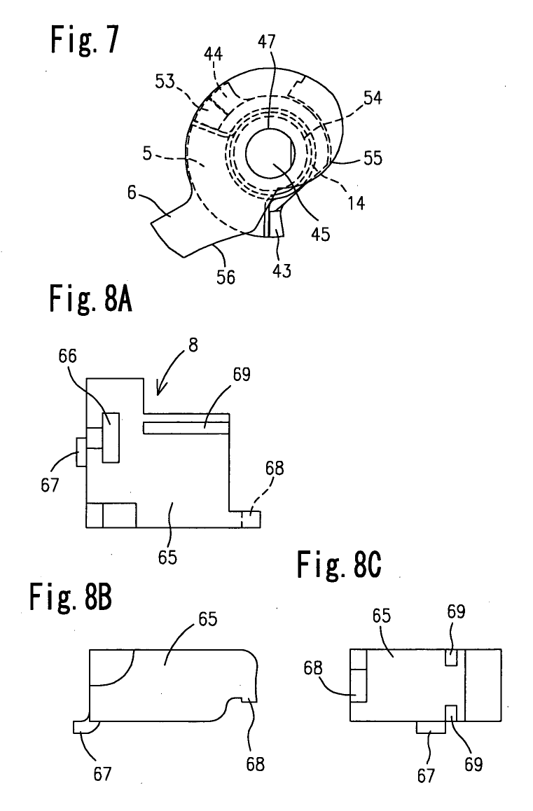

The cam member 6, as shown in FIGS. 6A and 6B, is composed of a cam portion 52 formed so that the distance from a bearing hole 51 formed at a rotational center is varied, a coupling convex portion 53 which is provided so as to protrude from the cam portion 52 toward the rotor 5 and which is to be engaged and coupled with the rotor 5, and a bushing portion 54 provided so as to cylindrically protrude from the cam portion 52 toward the rotor 5 side, where a bearing hole runs through the center of the bushing portion 54. Then, this cam member 6, as shown in FIG. 7, is pivotably held by the rotational portion 47 of the shaft 45, and the coupling convex portion 53 of the cam member 6 is to be engaged with the rotation-use engagement convex portion 44 of the rotor 5 so that the cam member 6 is rotated by the rotation of the rotor 5. Between the cam member 6 and the rotor 5, is provided a spring 14, which is disposed in a state that one end of the spring 14 is engaged with the spring-use engagement convex portion 43 of the rotor 5 while the other end is engaged with the coupling convex portion 53 of the cam member 6. That is, when the rotor 5 is rotated counterclockwise, the rotation-use engagement convex portion 44 is engaged with the coupling convex portion 53 so that the rotor 5 and the cam member 6 are rotated together. On the other hand, as the rotor 5 is rotated clockwise, the rotor 5 causes the cam member 6 to be rotated via the spring 14. As a result of this, even when the cam member 6 is unrotatable, the rotor 5 is rotated clockwise so that biasing force can be accumulated on the spring 14.

The cam portion 52 of the cam member 6 has a first cam wall surface 55 which presses the contact surface 22 of the first lock bolt 1 toward the steering shaft 97 by the cam member 6 rotating clockwise so that the first lock bolt 1 is rotated from the retreat position to the protrusion position. The cam member 6 also has a second cam wall surface 56 which presses the contact surface 22 of the first lock bolt 1 outward (toward a side away from the steering shaft 97) by the cam member 6 rotating counterclockwise so that the first lock bolt 1 is rotated from the protrusion position to the retreat position. Further, on the peripheral surface of the cam portion 52 is formed a receiving recess 57 for receiving the slider 8 coupled to the later-described solenoid 7. This receiving recess 57 is provided with an engagement portion 58 as a holding means which is to be engaged with the slider 8 to restrict the slider 8 from moving toward the solenoid 7. The engagement portion 58 comprises an end wall of the receiving recess 57 which is the first engagement portion, and a claw-like projection which is the second engagement portion.

The solenoid 7, which is fixed on the cover 12, is actuated by a start-up signal from the internal control circuit 60, and a plunger 61 is moved toward the solenoid 7 side in its actuated state. To a tip end portion of this plunger 61 is coupled the slider 8 which is to be engaged with the end wall of the receiving recess 57 of the cam member 6 to block the rotation of the cam member 6. Between this slider 8 and the solenoid 7 is provided a spring 62 with the plunger 61 serving as the axial center, so that the slider 8 is biased toward the cam member 6 by the biasing force of the spring 62 while the solenoid 7 is not actuated. In this embodiment, the solenoid 7, the slider 8 and the spring 62 constitute a rotation blocking means.

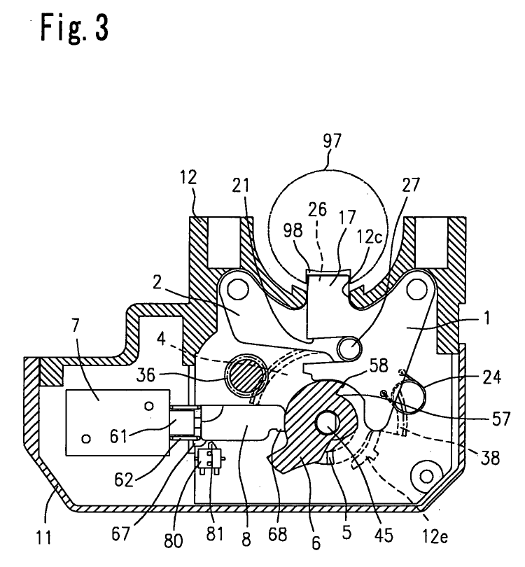

The slider 8, as shown in FIGS. 8A, 8B and 8C, comprises a generally rectangular-parallelopiped body portion 65, where a coupling recess 66 for fitting thereinto a tip end of the plunger 61 of the solenoid 7 so that the plunger 61 is coupled therewith, and an actuation detection piece 67 provided so as to protrude from the body portion 65 is formed on a downward side of the coupling recess 66. This actuation detection piece 67 serves to press a detection portion 81 of a solenoid switch 80 (see FIG. 3) for detecting a move of the slider 8, and this solenoid switch 80 is turned on when the slider 8 has moved to a position where the slider 8 is engageable with the cam member 6. Also, on the right-side frontage of the body portion 65 is protrusively provided an engagement claw portion 68 which intrudes into the receiving recess 57 of the cam member 6 so as to be engaged with the engagement portion 58. Further, on rear-side upper and lower surfaces of the body portion 65 are provided two rail recesses 69, respectively, into which rail-shaped convex portions 12f (one of which is shown in FIG. 1) of the cover 12 to restrict moves of the slider 8 except its rightward and leftward moves in FIG. 3. This is intended to prevent the slider 8 from moving upward and downward in FIG. 3 even-if the rotational force of the cam member 6 acts on the slider 8, so that forced thrust is not applied to the plunger 61 of the solenoid 7, thus producing an effect of preventing failures of the solenoid 7.

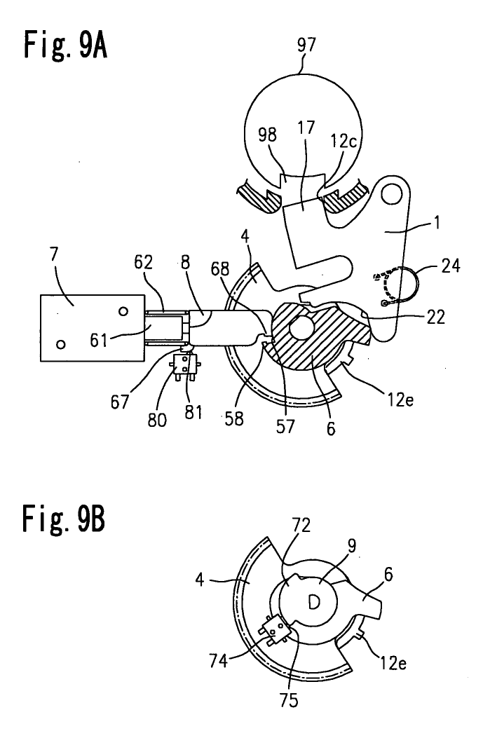

The switch cam 9, which is purposed to detect the rotational position of the final reduction gear 4, is coupled to the tip end portion 46 of the shaft 45 as shown in FIG. 1 so as to be rotated together with the shaft 45. On the outer circumferential wall of this switch cam 9 is provided a switch pressing portion 72 which protrudes toward the outer side in a fan shape as shown in FIG. 9B. This switch pressing portion 72 presses a detection portion 75 of an unlock switch 74 for detecting a rotation of the switch cam 9, and this unlock switch 74 is turned on when the shaft 45, the rotor 5 and the cam member 6, all of which are rotated together counterclockwise, have been rotated to a specified position shown in FIG. 9A.

Next, operation of the electrically-operated steering lock device having the above constitution is described.

FIG. 2 and FIG. 3 show a state that the lock bolts 1, 2 of the electrically-operated steering lock device are in a protrusion position where they are protruded from the opening portion 12c of the cover 12 in a stopped automobile. In this state, the electric motor 3 is in a halt state and the final reduction gear 4 is at a clockwise-rotated position, where one end face of the final reduction gear 4 is in contact with the stopper 12e. Also, the solenoid 7 is in an OFF state, and the slider 8 is kept in contact with a side face of the cam member 6 by the biasing force of the spring 62. At this time, the plunger 61 is in the pushed-out position, and the solenoid switch 80 operative in response to the actuation detection piece 67 of the slider 8 is in the OFF state. Further, the unlock switch 74 for detecting a rotation of the switch cam 9 is in the OFF state.

Upon input of a signal for releasing the lock of steering from a vehicle-side control circuit (not shown) in this state, a signal for rotating reverse the electric motor 3 is delivered from the internal control circuit 60, and with a current fed to the electric motor 3, the electric motor 3 is rotated, by which the final reduction gear 4, the rotor 5, the shaft 45, the switch cam 9, and the cam member 6 of which the coupling convex portion 53 is engaged with the rotation-use engagement convex portion 44 of the rotor 5 are rotated together counterclockwise via the rotating mechanism 31.

As the cam member 6 is rotated counterclockwise, the second cam wall surface 56 of the cam member 6 is brought into contact with the contact surface 22 of the first lock bolt 1, and the first lock bolt 1 is pressed in the retreat direction, thereby rotated counterclockwise. Also, the coupling convex portion 27 of the second lock bolt 2 protruded into the coupling-use concave portion 21 of the first lock bolt 1 is moved while keeping the engagement, the second lock bolt 2 is also pressed in the retreat direction, thereby rotated clockwise. Then, as shown in FIG. 4, the protruding pieces 17, 26 of the first and second lock bolts 1, 2 separate away from the receiving portion 98 of the steering shaft 97 of the vehicle. As a result, the engagement between the steering shaft 97 and the lock bolts 1, 2 is released, by which the steering shaft 97 is unlocked.

Then, when the cam member 6 is rotated up to a position shown in FIG. 9A, i.e., a position where the other end face of the final reduction gear 4 makes contact with the stopper 12e, the engagement claw portion 68 of the slider 8 goes beyond the engagement portion 58 from on the side face of the cam member 6, plunging into the receiving recess 57 from the position of FIG. 3 by the biasing force of the spring 62. In this case, the solenoid switch 80 comes to an ON state, and the unlock switch 74 also comes to an ON state.

The internal control circuit 60, upon reception of signals indicating an ON for the solenoid switch 80 and an ON for the unlock switch 74, outputs a signal to rotate the electric motor 3 a little forward. As a result, with a current fed to the electric motor 3, the electric motor 3 is rotated a little forward, so that the final reduction gear 4 is rotated a little clockwise via the rotating mechanism 31, where the rotor 5, the shaft 45, and the switch cam 9, together with the cam member 6 that is pressed against the rotor 5 via the spring 14, are rotated a little clockwise. In this case, even if the cam member 6 is rotated a little clockwise, the first cam wall surface 55 of the cam member 6 is not engaged with the contact surface 22 of the first lock bolt 1, and the first lock bolt 1, which is biased toward the retreat position by the action spring 24, keeps held in the retreat position.

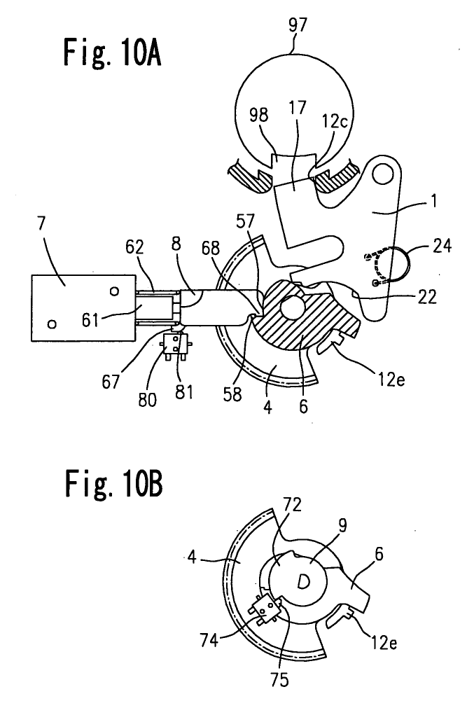

Then, as shown in FIGS. 10A and 10B, the engagement claw portion 68 of the slider 8 is engaged with the engagement portion 58 while kept in contact with the bottom face of the receiving recess 57. In this case, the unlock switch 74 is turned OFF, by which the internal control circuit 60, receiving a signal indicating an OFF of the unlock switch 74, cuts off the power supply to the electric motor 3.

In this state, even if an action for rotating the cam member 6 clockwise is exerted in the event that, for example, noise has entered into the internal control circuit 60, from which a signal for rotating forward the electric motor 3 is issued so that the electric motor 3 is rotated forward, the cam member 6 never rotates by its clockwise rotation being restricted by the slider 8 of which the engagement claw portion 68 is engaged with the end wall, as a part of the engagement portion 58, of the receiving recess 57 of the cam member 6. Thus, the lock bolts 1, 2 are never moved from the retreat position to the protrusion position, so that the steering shaft 97 is never locked.

Also, even in the event that special noise has entered into the internal control circuit 60, from which a signal for rotating forward the electric motor 3 and a signal for activating the solenoid 7 are issued simultaneously, the plunger 61, even if subject to an attempt for attracting the plunger 61, never moves by virtue of the engagement of the engagement claw portion 68 of the slider 8 with the claw-like projection as a part of engagement portion 58 of the cam member 6. Further, since the cam member 6 is subject to an action of clockwise rotational force by the electric motor 3, the engaging force between the engagement claw portion 68 of the slider 8 and the engagement portion 58 of the cam member 6 becomes larger proportionally, allowing the plunger 61 to be held securely. Thus, the cam member 6 is never allowed to rotate.

In the event that a signal for rotating reverse the electric motor 3 and a signal for activating the solenoid 7 have been issued simultaneously from the internal control circuit 60 on account of an abnormality signal, the plunger 61 is attracted, but the cam member 6 has been rotated counterclockwise and therefore the lock bolts 1, 2 never protrude. Then, upon a cease of the abnormality signal, the solenoid 7 is stopped from activation, the engagement claw portion 68 of the slider 8 is protruded into the receiving recess 57 by the biasing force of the spring 62, thus becoming engageable with the engagement portion 58 while kept in contact with the bottom face of the receiving recess 57.

As described above, even if noise has entered into the internal control circuit 60 during the running so that a signal for rotating forward the electric motor 3 and a signal for driving the solenoid 7 are issued from the internal control circuit 60, the lock bolts 1, 2 are never moved in the protruding direction, hence high safety.

Further, in the electrically-operated steering lock device of this embodiment, not that the lock bolts 1, 2 are actuated to the protrusion position by biasing force of a spring or the like, but that the lock bolts 1, 2 are moved to the protrusion position by the cam member 6. Therefore, even in the event that the engagement between the engagement claw portion 68 of the slider 8 and the engagement portion 58 of the cam member 6 is released for some reason, causing strong vibrations to act during the running of the vehicle, the lock bolts 1, 2 are never mis-protruded, so that the safety can be further improved.

When a signal for locking the steering is transmitted from the vehicle-side control circuit to the internal control circuit 60, a signal for rotating reverse the electric motor 3 is issued from the internal control circuit 60, in which case the cam member 6 is rotated from the position shown in FIG. 10A to the position shown in FIG. 9A. Then, the unlock switch 74 is turned ON, and a signal for activating the solenoid 7 is issued from the internal control circuit 60, causing the solenoid 7 to be driven, so that the plunger 61 and the slider 8 are attracted to positions where those escape from the receiving recess 57 against the biasing force of the spring 62.

In this case, even if the cam member 6 is rotated counterclockwise to the position shown in FIG. 9A, the second cam wall surface 56 of the cam member 6 is not engaged with the contact surface 22 of the first lock bolt 1, so that the first lock bolt 1 is not activated.

Then, when the solenoid switch 80 is turned off, a signal for rotating forward the electric motor 3 is issued from the internal control circuit 60. Thus, the electric motor 3 is rotated forward, so that the final reduction gear 4, the rotor 5, the shaft 45 and the switch cam 9, together with the cam member 6 pressed against the rotor 5 via the spring 14, are rotated clockwise via the rotating mechanism 31.

As the cam member 6 is rotated, the first cam wall surface 55 of the cam member 6 is brought into contact with the contact surface 22 of the first lock bolt 1, and the first lock bolt 1 is pressed in the protruding direction so as to be rotated clockwise. Further, the coupling convex portion 27 of the second lock bolt 2 protruding into the coupling-use concave portion 21 of the first lock bolt 1 is moved in engagement, the second lock bolt 2 is also pressed in the protruding direction so as to be rotated counterclockwise. In this operation, the protruding pieces 17, 26 of the first and second lock bolts 1, 2 are protruded outward from the opening portion 12c of the cover 12, entering into the receiving portion 98 of the steering shaft 97 of the vehicle and thereby being engaged with the receiving portion 98 of the steering shaft 97, by which the steering shaft 97 is locked.

Then, as the cam member 6 is rotated to the position shown in FIG. 2, one end face of the final reduction gear 4 is brought into contact with the side wall of the stopper 12e of the cover 12, thereby inhibited from rotation, and after a specified time elapse, the power supply to the motor 3 is cut off. Thereafter, the internal control circuit 60 halts the conduction to the solenoid 7, where the slider 8 comes into contact with the side face of the cam member 6 by the biasing force of the spring 62. Thus, the electrically-operated steering lock device comes into the lock state as shown in FIGS. 2 and 3.

As described above, with the constitution that the lock bolts 1, 2 are not actuated at the time of the release operation that the engagement between the engagement claw portion 68 of the slider 8 and the engagement portion 58 of the cam member 6 is released by rotating reverse the electric motor 3, there is no need for rotating the lock bolts 1, 2 from the retreat position further in the retreat direction, so that the working range of the lock bolts 1, 2 can be narrowed, thus making it possible to downsize the electrically-operated steering lock device.

It is noted that this embodiment may be changed in the following modes.

Although the solenoid 7 is driven after the first lock bolt 1 is moved from the position shown in FIG. 10A to the position shown in FIG. 9A in the above embodiment, the solenoid 7 may also be driven simultaneously. In this case, because of the concurrent timing of conduction for both the solenoid 7 and the electric motor 3, the response speed can be made faster to a degree of its effect.

Although the solenoid 7, the slider 8 and the spring 62 constitute a rotation blocking means in the above embodiment, it is also possible that the tip end portion of the plunger 61 of the solenoid 7 is engaged directly with the engagement portion 58 of the cam member 6, or that the slider 8 is activated by an electric motor or the like.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. An electrically-operated steering lock device comprising a lock bolt which is movable between a protrusion position where a steering shaft is locked and a retreat position where the steering shaft is unlocked, and a cam member which is rotated by an electric motor to actuate the lock bolt, the electrically-operated steering lock device further comprising: rotation blocking means which is electrically driven and which, when the lock bolt is placed at the retreat position, engages with a first engagement portion formed in the cam member to block rotation of the cam member; and holding means for holding the rotation blocking means in a state that rotation of the cam member is blocked.

2. The electrically-operated steering lock device according to claim 1, wherein the cam member acts to move the lock bolt to the protrusion position when the electric motor is rotated forward, and to move the lock bolt to the retreat position when the electric motor is rotated reverse.

3. The electrically-operated steering lock device according to claim 2, wherein the holding means is a second engagement portion formed in the cam member, and in a state that engagement with the second engagement portion has been released by reverse rotation of the electric motor, the lock bolt is protrudable by forward rotation of the electric motor.

4. The electrically-operated steering lock device according to claim 3, wherein a cam portion of the cam member is formed in such a manner that the lock bolt is not actuated at a time of release operation that the engagement with the second engagement portion is released by reverse rotation of the electric motor.

5. The electrically-operated steering lock device according to claim 4, further comprising lock bolt holding means for holding the lock bolt at the retreat position while the lock bolt is placed at the retreat position.
